(19) United States
(12) Patent Application Publication
(10) Pub. No.: US 2026/0168900 A1
(43) Pub. Date: Jun. 18, 2026

(54) EXPERIMENTAL SYSTEM, TESTING METHODS AND STRENGTH EVALUATING TECHNOLOGIES FOR GEOTECHNICAL MATERIAL UNDER COMPLEX DYNAMIC CONDITIONS IN EARTHQUAKE-PRONE MOUNTAINOUS AREA

(71) Applicant: Southwest Jiaotong University, Chengdu (CN)

(72) Inventors: Yingbin ZHANG, Chengdu (CN); Pengcheng YU, Chengdu (CN); Hui ZHU, Chengdu (CN); Jiangtao WEI, Chengdu (CN); Dejian LI, Chengdu (CN); Zhiwang CHANG, Chengdu (CN); Jing LIU, Chengdu (CN); Yin CHENG, Chengdu (CN); Shihao ZHANG, Chengdu (CN); Quanyu ZHAN, Chengdu (CN); Yukun LONG, Chengdu (CN)

(21) Appl. No.: 19/490,107

(22) PCT Filed: Jul. 29, 2025
(86) PCT No.: PCT/CN2025/111348

§ 371 Date: Dec. 4, 2025

(30) Foreign Application Priority Data
Aug. 9, 2024 (CN) 202411091683.6

(51) Int. Cl. G01N 3/02; G01N 3/24

(52) U.S. Cl. CPC G01N 3/02; G01N 3/24

(57) ABSTRACT

The present invention relates to an integrated large-scale triaxial dynamic geotechnical shear testing system and a testing method. The integrated large-scale triaxial dynamic geotechnical shear testing system includes a four-column loading frame, a shear box, a z-axis servo cylinder, an x-axis servo cylinder, a y-axis servo cylinder, a specimen transport system, a hydraulic system, a cooling system, a data collection system, a computer control system, and a computer control cabinet. The shear box may be transported into the four-column loading frame through the specimen transport system. The computer control system is electrically connected to the computer control cabinet. The hydraulic system, the cooling system, and the data collection system are all electrically connected to the computer control system. The present invention achieves the following beneficial effects: triaxial direct shear, triaxial simple shear, or triaxial cyclic shear tests of geotechnical materials under conditions of a constant normal load, constant normal stiffness, and a dynamic normal load can be achieved, enabling the study on an influence of seismic motion multi-directionality on dynamic properties of rocks, which helps reveal a mechanism of slope dynamic instability.

### FIELD OF THE INVENTION

The present invention relates to the field of geomechanical testing technologies, and in particular, to an integrated large-scale triaxial dynamic geotechnical shear testing system and a testing method.

### BACKGROUND OF THE INVENTION

Geotechnical materials are ubiquitous in nature, and are a collective term for rocks and soils. The two may transform into each other under various factors including geological processes, climatic conditions, biological actions, and human engineering activities, mechanical properties thereof differ significantly. Most engineering geological issues involve determination of values of mechanical parameters for fractured rock masses and soil-rock mixtures. In practical engineering, strength of the geotechnical materials is critical to engineering safety. In particular, China's seismically hyperactive southwestern region, situated between the Pacific seismic belt and the Himalayan-Mediterranean seismic belt, is one of the most tectonically vigorous continental zones worldwide. Cumulative damage of geotechnical materials subjected to external forces such as earthquakes becomes one of critical triggers for instability in slope and tunnel engineering.

A seismic load exhibits both dynamic characteristics and cyclic properties. The dynamic characteristics are reflected in the fact that the geotechnical materials, when sheared, may be affected by load amplitudes, frequencies, and loading rates. The cyclic properties are specifically reflected in degradation of shear strength parameters under a cyclic share load. For near-field strong earthquakes, the seismic load is multi-directional. That is, seismic effects on a same data monitoring point in different orientations vary significantly. Under an influence of the seismic load, slope rock masses or tunnel engineering may undergo dislocation and sliding along weak planes, ultimately leading to instability. A shear testing apparatus is a critical device for investigating shear mechanical properties, a failure mechanism, and an instability sliding mechanism of the geotechnical materials. Most current shear testing systems have shortcomings in loading ranges, boundary conditions, and functional adaptability of shear boxes. Specifically, these systems cannot meet a shear loading force of large-scale specimens, cannot simulate triaxial dynamic characteristics, and cannot simultaneously meet shear requirements of specimens such as rock masses and soil-rock mixtures.

However, constrained by functional limitations of a geomechanical testing apparatus, research on strength attenuation laws and dynamic characteristics of the geotechnical materials under the seismic load requires urgent in-depth investigation. Therefore, there is a need to develop an integrated large-scale triaxial dynamic geotechnical shear testing system (integrated large-scale triaxial dynamic geotechnical shear testing system (LVDDCS-R/S)) that can implement the above functions.

### SUMMARY OF THE INVENTION

An objective of the present invention is to provide an integrated large-scale triaxial dynamic geotechnical shear testing system and a testing method, so as to overcome the shortcomings of the prior art, which can achieve triaxial direct shear, triaxial simple shear, or triaxial cyclic shear tests of geotechnical materials under conditions of a constant normal load, constant normal stiffness, and a dynamic normal load and loading of custom waveforms (including pulse loads) in normal and tangential directions, enabling the study on an influence of seismic motion multi-directionality on dynamic properties of rocks, which helps reveal a mechanism of slope dynamic instability.

The objective of the present invention is achieved through the following technical solution.

The present invention provides an integrated large-scale triaxial dynamic geotechnical shear testing system, including a four-column loading frame, a shear box, a z-axis servo cylinder, an x-axis servo cylinder, a y-axis servo cylinder, a specimen transport system, a hydraulic system, a cooling system, a data collection system, a computer control system, and a computer control cabinet. The shear box is arranged in the four-column loading frame. The z-axis servo cylinder is arranged at the top of the four-column loading frame and vertically acts on the shear box through a z-axis press head, the x-axis servo cylinder and the y-axis servo cylinder are arranged on side walls of the four-column loading frame and horizontally act on the shear box, one side of the four-column loading frame is provided with an opening, the specimen transport system is arranged at the opening, the shear box is transported into the four-column loading frame through the specimen transport system, and the shear box is a simple shear box or a direct shear box. The hydraulic system is configured to supply hydraulic oil to the z-axis servo cylinder, the x-axis servo cylinder, and the y-axis servo cylinder, and the cooling system is configured to cool the hydraulic oil supplied by the hydraulic system. The data collection system is configured to measure and collect loading parameters of the z-axis servo cylinder, the x-axis servo cylinder, and the y-axis servo cylinder. The computer control system is electrically connected to the computer control cabinet, and the hydraulic system, the cooling system, and the data collection system are all electrically connected to the computer control system.

Further, the specimen transport system includes a linear guide rail, a triangular support frame, a fastening backup nut, a reaction pull rod, a tray, a friction-reducing ball strip, and an x-axis friction-reducing roller array, wherein the linear guide rail is fixed at the opening of the four-column loading frame through the triangular support frame, the tray is slidably arranged on the linear guide rail, the reaction pull rod is arranged on one side of the tray, the reaction pull rod passes through a side wall that is on the four-column loading frame and opposite to the opening and is connected to the fastening backup nut, the fastening backup nut abuts against an outer side wall of the four-column loading frame, a top surface of the tray is provided with a groove along an operating direction of the x-axis servo cylinder, the x-axis friction-reducing roller array is arranged, in a rolling manner, at the bottom of the groove, the shear box is arranged in the groove and supported on the x-axis friction-reducing roller array, the friction-reducing ball strip is arranged, in a rolling manner, on a side wall of the groove and is in rolling contact with the shear box, and a side wall of the tray is provided with a stopper capable of abutting against the x-axis friction-reducing roller array.

Further, the simple shear box includes the base, an upper stacked-ring shear box, a guiding column, the y-axis friction-reducing roller array, the shear press head, an acoustic emission stacked ring, a common stacked ring, the x-axis reaction backing plate, the x-axis reaction backup nut, a lower stacked-ring shear box, the y-axis reaction backup nut, the connection backup nut, and the y-axis reaction backing plate, wherein the lower stacked-ring shear box is arranged on the base, the common stacked ring is arranged at the top of the lower stacked-ring shear box, the acoustic emission stacked ring is arranged at the top of the common stacked ring, the upper stacked-ring shear box is arranged at the top of the acoustic emission stacked ring, the shear press head is arranged at the top of the upper stacked-ring shear box, the y-axis friction-reducing roller array is arranged, in a rolling manner, at the top of the shear press head, the z-axis press head is supported on the y-axis friction-reducing roller array, a loading end of the z-axis servo cylinder abuts against the z-axis press head, the guiding column detachably passes through the upper stacked-ring shear box and is downwards inserted into the lower stacked-ring shear box, the acoustic emission stacked ring and the common stacked ring sleeve the guiding column, the x-axis reaction backing plate is arranged on a side wall of the lower stacked-ring shear box, the x-axis reaction backup nut is arranged on the x-axis reaction backing plate, a loading end of the x-axis servo cylinder abuts against the x-axis reaction backup nut, the y-axis reaction backing plate is arranged on a side wall of the upper stacked-ring shear box, the y-axis reaction backup nut is arranged on the y-axis reaction backing plate through the connection backup nut, and a loading end of the y-axis servo cylinder abuts against the y-axis reaction backup nut.

Further, the direct shear box includes a base, a y-axis friction-reducing roller array, a shear press head, an x-axis reaction backing plate, an x-axis reaction backup nut, a y-axis reaction backup nut, a connection backup nut, a y-axis reaction backing plate, an upper direct shear box, and a lower direct shear box, wherein the lower direct shear box is arranged on the base, the upper direct shear box is arranged at the top of the lower direct shear box, the shear press head is arranged at the top of the upper direct shear box, the y-axis friction-reducing roller array is arranged, in a rolling manner, at the top of the shear press head, the z-axis press head is supported on the y-axis friction-reducing roller array, a loading end of the z-axis servo cylinder abuts against the z-axis press head, the x-axis reaction backing plate is arranged on a side wall of the lower direct shear box, the x-axis reaction backup nut is arranged on the x-axis reaction backing plate, a loading end of the x-axis servo cylinder abuts against the x-axis reaction backup nut, the y-axis reaction backing plate is arranged on a side wall of the upper direct shear box, the y-axis reaction backup nut is arranged on the y-axis reaction backing plate through the connection backup nut, and a loading end of the y-axis servo cylinder abuts against the y-axis reaction backup nut.

Further, the base is arranged within the groove and supported on the x-axis friction-reducing roller array, and the friction-reducing ball strip is in rolling contact with a side wall of the base.

Further, the direct shear box is provided with a shear assembly, the shear assembly including a plurality of integrated shear boxes of different sizes, the plurality of integrated shear boxes being nested sequentially in ascending order of the sizes, a specimen being placed inside the shear assembly, a vertical friction-reducing assembly being arranged between a periphery of the shear assembly and the direct shear box, the vertical friction-reducing assembly including a vertical friction-reducing roller array and a friction-reducing plate, the vertical friction-reducing roller array being located between the shear assembly and the friction-reducing plate, the vertical friction-reducing roller array abutting against both the shear assembly and the friction-reducing plate, the friction-reducing plate abutting against an inner wall of the upper direct shear box, and the friction-reducing plate being provided with a reserved acoustic emission hole.

Further, the data collection system includes a z-axis magnetostrictive displacement sensor, an x-axis magnetostrictive displacement sensor, a y-axis magnetostrictive displacement sensor, a z-axis shear-beam load cell, an x-axis Fulun sensor, and a y-axis Fulun sensor, wherein the z-axis magnetostrictive displacement sensor, the x-axis magnetostrictive displacement sensor, and the y-axis magnetostrictive displacement sensor are respectively arranged on a cylinder end face of the z-axis servo cylinder, a cylinder end face of the x-axis servo cylinder, and a cylinder end face of the y-axis servo cylinder, one end of the z-axis shear-beam load cell is connected to the loading end of the z-axis servo cylinder through a load cell backup nut, the other end of the z-axis shear-beam load cell abuts against the z-axis press head through a ball-head compression plate, the x-axis Fulun sensor is arranged at the loading end of the x-axis servo cylinder and abuts against the x-axis reaction backup nut, and the y-axis Fulun sensor is arranged at the loading end of the y-axis servo cylinder and abuts against the y-axis reaction backup nut.

Further, the four-column loading frame is provided with a connection base at the top, a cylinder barrel of the z-axis servo cylinder is connected to the connection base through a heightened flange, side walls of the four-column loading frame are provided with an x-axis Fulun sensor connecting hole and a y-axis Fulun sensor connecting hole, a cylinder barrel of the x-axis servo cylinder is arranged at the x-axis Fulun sensor connecting hole through a coupling flange, the loading end of the x-axis servo cylinder passes through the x-axis Fulun sensor connecting hole and is connected to the x-axis Fulun sensor, a cylinder barrel of the y-axis servo cylinder is arranged at the y-axis Fulun sensor connecting hole through a coupling flange, the loading end of the y-axis servo cylinder passes through the y-axis Fulun sensor connecting hole and is connected to the y-axis Fulun sensor, and the four-column loading frame is further provided with a hoist ring at the top.

Further, based on the above integrated large-scale triaxial dynamic geotechnical shear testing system, the present invention further provides a shear testing method, including the following steps:

S1: performing startup and checking whether devices and instruments are normal;

S2: selecting a shear box of a corresponding type and size according to a type and size of the specimen, placing the shear box on the x-axis friction-reducing roller array in the specimen transport system, and then placing the specimen into the shear box;

S3: transporting the shear box to a position directly below the z-axis press head by the specimen transport system, causing the reaction pull rod to pass through the side wall of the four-column loading frame, and then tightening the fastening backup nut;

S4: applying a preset normal pressing force to the shear box through the z-axis servo cylinder, then applying an initial tangential pressing force to the shear box through the x-axis servo cylinder and the y-axis servo cylinder respectively, and finally performing different types of shear tests on the specimen under a condition of a constant normal load, a dynamic normal load, or constant normal stiffness through the z-axis servo cylinder, the x-axis servo cylinder, and the y-axis servo cylinder until the specimen reaches a preset shear displacement or deformation, and collecting, by the data collection system during the tests, loading parameters of the z-axis servo cylinder, the x-axis servo cylinder, and the y-axis servo cylinder; and

S5: after the specimen reaches the preset shear displacement or deformation, performing automatic shutdown and saving test data, and processing and analyzing, by the computer control system, the data collected by the data collection system.

Further, the shear tests include three types: triaxial simple shear tests, triaxial direct shear tests, and triaxial cyclic shear tests.

Compared with the prior art, the present invention achieves the following beneficial effects.

According to the present invention, triaxial simple shear tests, triaxial direct shear tests, and triaxial cyclic shear tests of geomaterial specimens under conditions of a constant normal load, constant normal stiffness, and a dynamic normal load can be achieved, the triaxial cyclic shear tests can achieve multi-directional dynamic loading shear in both horizontal and vertical directions, as well as strain-rate and multi-frequency-band loading under seismic loads (including pulse loads). By using the integrated large-scale triaxial dynamic geotechnical shear testing system in the present invention, an influence of seismic motion multi-directionality on dynamic properties of rocks can be studied, which helps reveal a mechanism of slope dynamic instability and has important significance for theoretical research and engineering design of the geotechnical materials.

### BRIEF DESCRIPTION OF THE DRAWINGS

FIG. 1 is a schematic diagram of an operating principle of an integrated large-scale triaxial dynamic geotechnical shear testing system according to the present invention;

FIG. 2 is a schematic diagram of a shear test loading structure of a shear box according to the present invention;

FIG. 3 is a schematic side view of a structure of a four-column loading frame of a main unit according to the present invention;

FIG. 4 is a schematic structural diagram of a specimen transport system according to the present invention;

FIG. 5 is a schematic diagram of an overall structure of a simple shear box according to the present invention;

FIG. 6 is a schematic diagram of an overall structure of a direct shear box according to the present invention;

FIG. 7 is a schematic structural diagram of a vertical friction-reducing assembly according to the present invention;

FIG. 8 is a schematic diagram of triaxial direct shear test data results according to the present invention; and

FIG. 9 is a schematic diagram of triaxial cyclic shear test data results according to the present invention.

In the figures, 1: computer control cabinet; 2: computer control system; 3: hydraulic system; 4: cooling system; 5: z-axis dynamic loading assembly; 6: x-axis dynamic loading assembly; 7: y-axis dynamic loading assembly; 8: simple shear box; 9: direct shear box; 10: Z-axis magnetostrictive displacement sensor; 11: z-axis servo cylinder; 12: heightened flange; 13: load cell backup nut; 14: z-axis shear-beam load cell; 15: ball-head compression plate; 16: z-axis press head; 17: shear box; 18: x-axis Fulun sensor; 19: x-axis servo cylinder; 20: x-axis magnetostrictive displacement sensor; 21: base; 22: y-axis magnetostrictive displacement sensor; 23: y-axis servo cylinder; 24: y-axis Fulun sensor; 25: four-column loading frame; 26: connection base; 27: hoist ring; 28: upright column; 29: linear guide rail; 30: x-axis Fulun sensor connecting hole; 31: triangular support frame; 32: fastening backup nut; 33: y-axis Fulun sensor connecting hole; 34: tray; 35: friction-reducing ball strip; 36: x-axis friction-reducing roller array; 37: stopper; 38: upper stacked-ring shear box; 39: guiding column; 40: y-axis friction-reducing roller array; 41: shear press head; 42: z-axis deformation sensor through hole; 43: acoustic emission stacked ring; 44: common stacked ring; 45: x-axis reaction backing plate; 46: x-axis reaction backup nut; 47: lower stacked-ring shear box; 48: y-axis reaction backup nut; 49: connection backup nut; 50: y-axis reaction backing plate; 51: friction-reducing plate; 52: vertical friction-reducing roller array; 53: upper direct shear box; 54: reserved acoustic emission hole; 55: lower direct shear box.

### DETAILED DESCRIPTION OF THE EMBODIMENTS

The present invention is further described below in conjunction with the accompanying drawings, but the protection scope of the present invention is not limited to the following description.

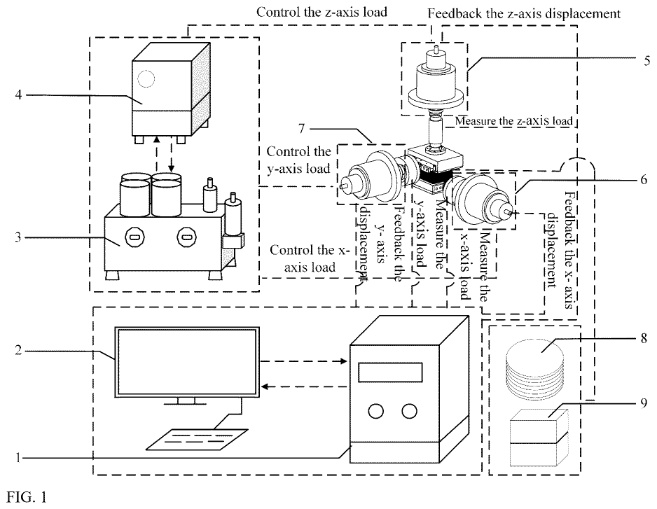

As shown in FIG. 1 to FIG. 7, an integrated large-scale triaxial dynamic geotechnical shear testing system includes a four-column loading frame 25, a shear box 17, a z-axis servo cylinder 11, an x-axis servo cylinder 19, a y-axis servo cylinder 23, a specimen transport system, a hydraulic system 3, a cooling system 4, a data collection system, a computer control system 2, and a computer control cabinet 1.

One side of the four-column loading frame 25 is provided with an opening, the specimen transport system is mounted at the opening, and the shear box 17 may be transported into the four-column loading frame 25 through the specimen transport system. The z-axis servo cylinder 11 is mounted at the top of the four-column loading frame 25 and vertically acts on the shear box 17 through a z-axis press head 16. The x-axis servo cylinder 19 and the y-axis servo cylinder 23 are mounted on side walls of the four-column loading frame 25 and horizontally act on the shear box 17.

The shear box 17 is a simple shear box 8 or a direct shear box 9. A shear box 17 of a corresponding type and size is selected according to a type and size of a specimen, then the specimen is placed into the shear box 17, hydraulic oil is supplied to the z-axis servo cylinder 11, the x-axis servo cylinder 19, and the y-axis servo cylinder 23 through the hydraulic system 3, the z-axis servo cylinder 11 is controlled to apply a normal pressing force to the shear box 17, and the x-axis servo cylinder 19 and the y-axis servo cylinder 23 are controlled to apply a tangential pressing force to the shear box 17, thereby performing a shear test on the specimen. During the test, the cooling system 4 is configured to cool the hydraulic oil supplied by the hydraulic system 3, to prevent an influence on normal operation of the device due to a rapid rise in an oil temperature during dynamic shear. The data collection system is configured to measure and collect loading parameters of the z-axis servo cylinder 11, the x-axis servo cylinder 19, and the y-axis servo cylinder 23. The computer control system 2 is electrically connected to the computer control cabinet 1, and the hydraulic system 3, the cooling system 4, and the data collection system are all electrically connected to the computer control system 2, thereby performing unified control and deployment on the hydraulic system 3, the cooling system 4, and the data collection system through the computer control system 2.

As shown in FIG. 4, the specimen transport system includes a linear guide rail 29, a triangular support frame 31, a fastening backup nut 32, a reaction pull rod, a tray 34, a friction-reducing ball strip 35, and an x-axis friction-reducing roller array 36. The linear guide rail 29 is fixed at the opening of the four-column loading frame 25 through the triangular support frame 31, the tray 34 is slidably arranged on the linear guide rail 29, the reaction pull rod is fixed to one side of the tray 34, the reaction pull rod passes through a side wall that is on the four-column loading frame 25 and opposite to the opening and is connected to the fastening backup nut 32, the fastening backup nut 32 abuts against an outer side wall of the four-column loading frame 25, a top surface of the tray 34 is provided with a groove along an operating direction of the x-axis servo cylinder 19, the x-axis friction-reducing roller array 36 is mounted, in a rolling manner, at the bottom of the groove, and the friction-reducing ball strip 35 is mounted, in a rolling manner, on a side wall of the groove. The shear box 17 is placed in the groove and supported on the x-axis friction-reducing roller array 36, and then the shear box 17 may be transported into the four-column loading frame 25 by sliding the tray 34 on the linear guide rail 29. When the shear box 17 is transported to a position directly below the z-axis press head 16, the reaction pull rod passes through the side wall of the four-column loading frame 25, and then the fastening backup nut 32 is tightened, so that the tray 34 is fixed. When the shear box 17 is placed in the groove, the friction-reducing ball strip 35 may be in rolling contact with the shear box 17. Through the arrangement of the x-axis friction-reducing roller array 36 and the friction-reducing ball strip 35, friction between the shear box 17 and the tray 34 during the shear test can be reduced, thereby improving accuracy of test results. In addition, a side wall of the tray 34 is provided with a stopper 37. During the shear test, the x-axis friction-reducing roller array 36 is forced to roll until abutment against the stopper 37, and then the stopper 37 can block the x-axis friction-reducing roller array 36 to prevent shearing of the x-axis friction-reducing roller array 36 out of the tray 34.

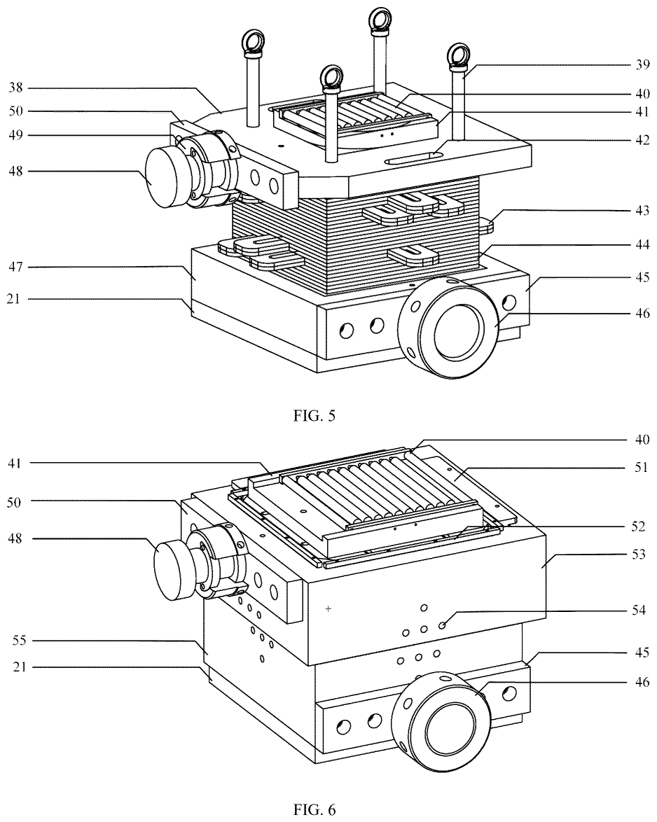

As shown in FIG. 5, the simple shear box 8 includes the base 21, an upper stacked-ring shear box 38, a guiding column 39, the y-axis friction-reducing roller array 40, the shear press head 41, an acoustic emission stacked ring 43, a common stacked ring 44, the x-axis reaction backing plate 45, the x-axis reaction backup nut 46, a lower stacked-ring shear box 47, the y-axis reaction backup nut 48, the connection backup nut 49, and the y-axis reaction backing plate 50. The lower stacked-ring shear box 47 is placed on the base 21, the common stacked ring 44 is arranged at the top of the lower stacked-ring shear box 47, the acoustic emission stacked ring 43 is arranged at the top of the common stacked ring 44, the upper stacked-ring shear box 38 is arranged at the top of the acoustic emission stacked ring 43, the shear press head 41 is arranged at the top of the upper stacked-ring shear box 38, and the y-axis friction-reducing roller array 40 is mounted, in a rolling manner, at the top of the shear press head 41. The z-axis press head 16 is supported on the y-axis friction-reducing roller array 40, a loading end of the z-axis servo cylinder 11 abuts against the z-axis press head 16, and then a normal pressing force may be applied to the shear box 17 through the z-axis press head 16. The guiding column 39 detachably passes through the upper stacked-ring shear box 38 and is downwards inserted into the lower stacked-ring shear box 47, and the acoustic emission stacked ring 43 and the common stacked ring 44 sleeve the guiding column 39. The x-axis reaction backing plate 45 is fixed to a side wall of the lower stacked-ring shear box 47, the x-axis reaction backup nut 46 is directly fixed to the x-axis reaction backing plate 45 through a screw, a loading end of the x-axis servo cylinder 19 abuts against the x-axis reaction backup nut 46, and then an x-axis tangential pressing force may be applied to the shear box 17 through the x-axis reaction backup nut 46 and the x-axis reaction backing plate 45. The y-axis reaction backing plate 50 is fixed to a side wall of the upper stacked-ring shear box 38, the y-axis reaction backup nut 48 is fixed to the y-axis reaction backing plate 50 through the connection backup nut 49, a loading end of the y-axis servo cylinder 23 abuts against the y-axis reaction backup nut 48, and then a y-axis tangential pressing force may be applied to the shear box 17 through the y-axis reaction backup nut 48 and the y-axis reaction backing plate 50. In addition, a z-axis deformation sensor through hole 42 is further reserved on the upper stacked-ring shear box 38, which may be configured to mount a linear variable differential transformer (LVDT) displacement sensor, so that the LVDT displacement sensor is in direct contact with the z-axis press head 16 via the Z-axis deformation sensor through hole 42. The LVDT displacement sensor serves as an additional accessory and may be added as required according to an actual test situation.

In this embodiment, a square stacked ring or a circular stacked ring may be selected as the acoustic emission stacked ring 43 and the common stacked ring 44 in the simple shear box 8. The square stacked ring includes four dimension specifications: 100 mm×100 mm, 150 mm×150 mm, 200 mm×200 mm, and 300 mm×300 mm. The circular stacked ring includes four dimension specifications: φ100 mm×100 mm, φ150 mm×150 mm, φ200 mm×200 mm, and φ300 mm×300 mm.

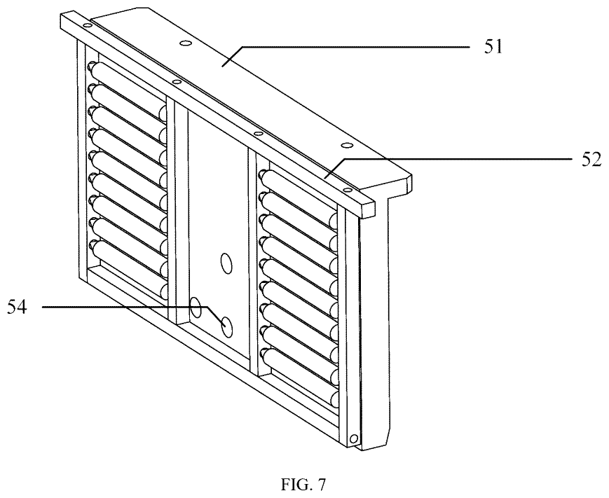

As shown in FIG. 6, the direct shear box 9 includes a base 21, a y-axis friction-reducing roller array 40, a shear press head 41, an x-axis reaction backing plate 45, an x-axis reaction backup nut 46, a y-axis reaction backup nut 48, a connection backup nut 49, a y-axis reaction backing plate 50, an upper direct shear box 53, and a lower direct shear box 55. The lower direct shear box 55 is placed on the base 21, the upper direct shear box 53 is arranged at the top of the lower direct shear box 55, the shear press head 41 is placed at the top of the upper direct shear box 53, the y-axis friction-reducing roller array 40 is mounted, in a rolling manner, at the top of the shear press head 41, the z-axis press head 16 is supported on the y-axis friction-reducing roller array 40, a loading end of the z-axis servo cylinder 11 abuts against the z-axis press head 16, and then a normal pressing force may be applied to the shear box 17 through the z-axis press head 16. The x-axis reaction backing plate 45 is fixed to a side wall of the lower direct shear box 55, the x-axis reaction backup nut 46 is directly fixed to the x-axis reaction backing plate 45 through a screw, a loading end of the x-axis servo cylinder 19 abuts against the x-axis reaction backup nut 46, and then an x-axis tangential pressing force may be applied to the shear box 17 through the x-axis reaction backup nut 46 and the x-axis reaction backing plate 45. The y-axis reaction backing plate 50 is fixed to a side wall of the upper direct shear box 53, the y-axis reaction backup nut 48 is fixed to the y-axis reaction backing plate 50 through the connection backup nut 49, a loading end of the y-axis servo cylinder 23 abuts against the y-axis reaction backup nut 48, and then a y-axis tangential pressing force may be applied to the shear box 17 through the y-axis reaction backup nut 48 and the y-axis reaction backing plate 50.

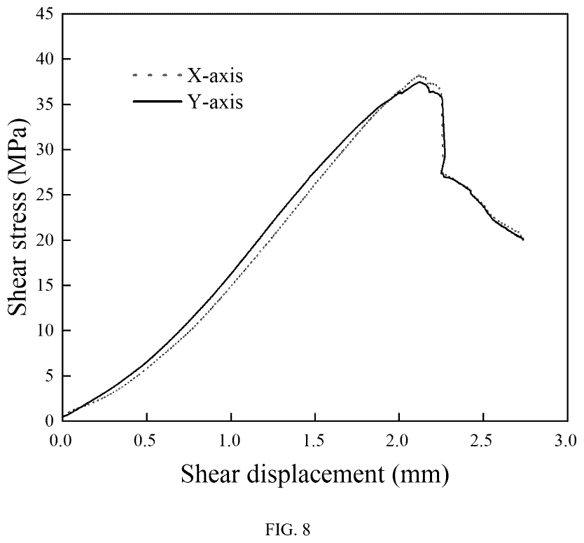

The direct shear box 9 is provided with a shear assembly. The shear assembly includes a plurality of integrated shear boxes of different sizes. In this embodiment, the integrated shear boxes are in the shape of a cube or a cylinder. The integrated shear boxes in the shape of the cube are available in four dimension specifications: 100 mm×100 mm, 150 mm×150 mm, 200 mm×200 mm, and 300 mm×300 mm, and the integrated shear boxes in the shape of the cylinder are available in four dimension specifications: φ100 mm×100 mm, φ150 mm×150 mm, φ200 mm×200 mm, and φ300 mm×300 mm. During the test, the plurality of integrated shear boxes in a same shape are nested sequentially in ascending order of the sizes to form the shear assembly. After the shear assembly is placed in the direct shear box 9, the specimen is placed in the shear assembly, and then direct shear testing of cubical specimens and cylindrical specimens can be implemented. As shown in FIG. 6 and FIG. 7, a vertical friction-reducing assembly is arranged between a periphery of the shear assembly and the direct shear box 9, the vertical friction-reducing assembly includes a vertical friction-reducing roller array 52 and a friction-reducing plate 51, the vertical friction-reducing roller array 52 is located between the shear assembly and the friction-reducing plate 51, the vertical friction-reducing roller array 52 abuts against both the shear assembly and the friction-reducing plate 51, the friction-reducing plate 51 abuts against an inner wall of the upper direct shear box 53, the vertical friction-reducing roller array 52 is configured to reduce contact friction between the shear assembly and the upper direct shear box 53 during the test, and the friction-reducing plate 51 is configured to reduce a gap between the upper direct shear box 53 and the shear assembly. The friction-reducing plate 51 is provided with a reserved acoustic emission hole, which may be used for acoustic emission testing.

Regardless of the simple shear box 8 or the direct shear box 9, when the shear box 17 is placed on the tray 34, the base 21 is located in the groove and supported on the X-axis friction-reducing roller array 36, while the friction-reducing ball strip 35 is in rolling contact with the side wall of the base 21.

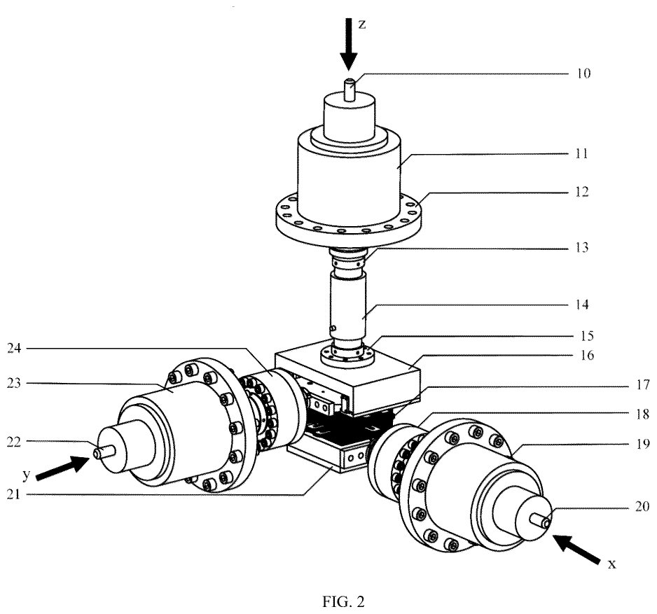

As shown in FIG. 2, the data collection system includes a z-axis magnetostrictive displacement sensor 10, an x-axis magnetostrictive displacement sensor 20, a y-axis magnetostrictive displacement sensor 22, a z-axis shear-beam load cell 14, an x-axis Fulun sensor 18, and a y-axis Fulun sensor 24. The z-axis magnetostrictive displacement sensor 10, the x-axis magnetostrictive displacement sensor 20, and the y-axis magnetostrictive displacement sensor 22 are respectively arranged on a cylinder end face of the z-axis servo cylinder 11, a cylinder end face of the x-axis servo cylinder 19, and a cylinder end face of the y-axis servo cylinder 23, and are respectively configured to collect loading displacements of the z-axis servo cylinder 11, the x-axis servo cylinder 19 and the y-axis servo cylinder 23. One end of the z-axis shear-beam load cell 14 is connected to the loading end of the z-axis servo cylinder 11 through a load cell backup nut 13, the other end of the z-axis shear-beam load cell 14 is connected to a ball-head compression plate 15 and then abuts against the z-axis press head 16 through the ball-head compression plate 15, and a normal load applied by the z-axis servo cylinder 11 can be collected through the z-axis shear-beam load cell 14. The x-axis Fulun sensor 18 is arranged at the loading end of the x-axis servo cylinder 19 and abuts against the x-axis reaction backup nut 46, and a tangential load applied by the x-axis servo cylinder 19 can be collected through the x-axis Fulun sensor 18. The y-axis Fulun sensor 24 is arranged at the loading end of the y-axis servo cylinder 23 and abuts against the y-axis reaction backup nut 48, and a tangential load applied by the y-axis servo cylinder 23 can be collected through the y-axis Fulun sensor 24.

In this embodiment, the z-axis magnetostrictive displacement sensor 10, the x-axis magnetostrictive displacement sensor 20, and the y-axis magnetostrictive displacement sensor 22 all have a measuring range of 130 mm and a measurement accuracy of ±0.5% F.S. Sampling frequencies for normal and tangential load and displacement data may vary within a range of 0 to 1000 Hz. The z-axis shear-beam load cell 14 has a measuring range of 2000 kN and a measurement accuracy of ±0.5% F.S. The x-axis Fulun sensor 18 and the y-axis Fulun sensor 24 both have a maximum measuring range of 1500 kN and a measurement accuracy of ±0.5% F.S.

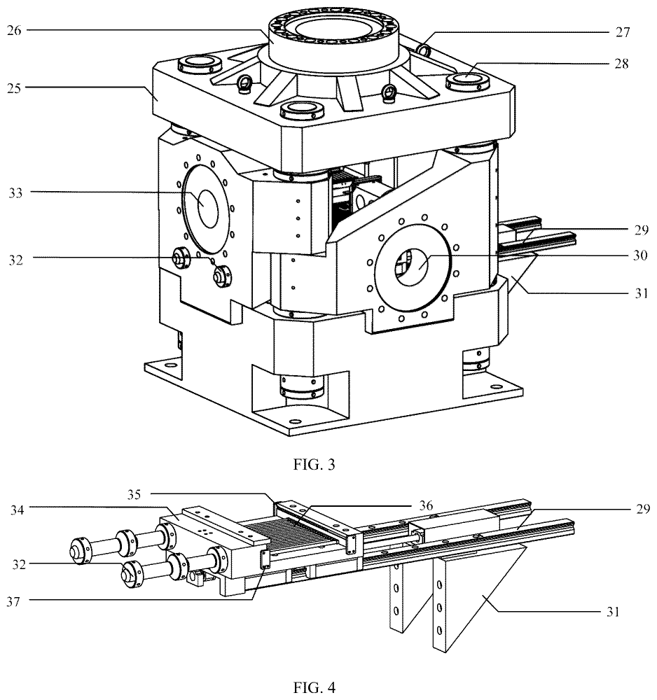

As shown in FIG. 3, the four-column loading frame 25 is connected and supported by four upright columns 28, a connection base 26 is fixed to the top of the four-column loading frame 25, a heightened flange 12 is fixed to a cylinder barrel of the z-axis servo cylinder 11, the heightened flange 12 is connected to the connection base 26 through a screw, and the loading end of the z-axis servo cylinder 11 passes through the connection base 26 into the four-column loading frame 25. Side walls of the four-column loading frame 25 are provided with a connecting hole for the x-axis Fulun sensor 18 and a connecting hole for the y-axis Fulun sensor 24, coupling flanges are fixed to cylinder barrels of the x-axis servo cylinder 19 and the y-axis servo cylinder 23, the coupling flange on the x-axis servo cylinder 19 is fixed at the connecting hole for the x-axis Fulun sensor 18 through a screw, the x-axis servo cylinder 19 is then mounted on the four-column loading frame 25, and the loading end of the x-axis servo cylinder 19 passes through the connecting hole for the x-axis Fulun sensor 18 and is connected to the x-axis Fulun sensor 18. The coupling flange on the y-axis servo cylinder 23 is fixed at the connecting hole for the y-axis Fulun sensor 24 through a screw, the y-axis servo cylinder 23 is then mounted on the four-column loading frame 25, and the loading end of the y-axis servo cylinder 23 passes through the connecting hole for the y-axis Fulun sensor 24 and is connected to the y-axis Fulun sensor 24. The four-column loading frame 25 is further provided with a hoist ring 27 at the top, to facilitate hoisting of the four-column loading frame 25.

As shown in FIG. 1 and FIG. 2, in this embodiment, the z-axis servo cylinder 11, the z-axis magnetostrictive displacement sensor 10, and the z-axis shear-beam load cell 14 constitute a z-axis dynamic loading assembly 5, the x-axis servo cylinder 19, the x-axis magnetostrictive displacement sensor 20, and the x-axis Fulun sensor 18 constitute an x-axis dynamic loading assembly 6, and the y-axis servo cylinder 23, the y-axis magnetostrictive displacement sensor 22, and the y-axis Fulun sensor 24 constitute a y-axis dynamic loading assembly 7. The computer control cabinet 1, the computer control system 2, the hydraulic system 3, the z-axis dynamic loading assembly 5, the x-axis dynamic loading assembly 6, the y-axis dynamic loading assembly 7, the z-axis magnetostrictive displacement sensor 10, the x-axis magnetostrictive displacement sensor 20, the y-axis magnetostrictive displacement sensor 22, the z-axis shear-beam load cell 14, the x-axis Fulun sensor 18, the y-axis Fulun sensor 24, together with a controller and a servo valve that are additionally provided, form a servo control system. A control principle of the servo control system is as follows: the computer control system 2 sends an instruction to the controller via Ethernet, the controller transmits the instruction to the servo valve via proportional-integral-derivative (PID) servo control, a size of an opening of the servo valve determines a size of a force on the shear box 17, and then the z-axis shear-beam load cell 14, the x-axis Fulun sensor 18 and the y-axis Fulun sensor 24 convert an electrical signal into a load size and transmit the load size to the controller, and the controller then feeds a signal back to the computer control system 2. Similarly, the z-axis magnetostrictive displacement sensor 10, the x-axis magnetostrictive displacement sensor 20, and the y-axis magnetostrictive displacement sensor 22 feed a displacement of a cylinder piston back to the controller, and the controller then feeds a signal back to the computer control system 2. Through the servo control system and the testing apparatus, triaxial direct shear, triaxial simple shear, or triaxial cyclic shear tests under conditions of a constant normal load, constant normal stiffness, and a dynamic normal load and closed-loop control over loading of custom waveforms (including pulse loads) in normal and tangential directions can be achieved.

The hydraulic system 3 has an existing structure, mainly including structures such as an oil tank, 4 oil pumps (motor units), a precision oil filter, a relief valve, a pressure gauge, an air filter, a bladder-type accumulator, and pipelines. Since a static loading cylinder and a dynamic loading actuator have different requirements for hydraulic oil flow rates and operating pressures during execution, in order to accurately control the cylinder, static loading and dynamic loading are driven by different oil pumps. 2 oil pumps drive the z-axis servo cylinder 11, and the other two oil pumps are responsible for driving the x-axis servo cylinder 19 and the y-axis servo cylinder 23 respectively. The bladder-type accumulator serves to increase an instantaneous flow rate of the servo cylinder to achieve rapid and dynamic disturbance shearing. The oil tank has a capacity of 1000 L. The oil tank is provided with a level gauge, enabling observation of a remaining volume of hydraulic oil at any time for timely replenishment.

When the above integrated large-scale triaxial dynamic geotechnical shear testing system is used for a shear test, the following steps are included:

In S1, startup is performed and it is checked whether devices and instruments are normal.

In S2, a shear box 17 of a corresponding type and size is selected according to a type and size of the specimen, the shear box 17 is placed on the x-axis friction-reducing roller array 36 in the specimen transport system, and then the specimen is placed into the shear box 17.

In S3, the shear box 17 is transported to a position directly below the z-axis press head 16 by the specimen transport system, causing the reaction pull rod to pass through the side wall of the four-column loading frame 25, and then the fastening backup nut 32 is tightened.

In S4, a preset normal pressing force is applied to the shear box 17 through the z-axis servo cylinder 11, then an initial tangential pressing force is applied to the shear box 17 through the x-axis servo cylinder 19 and the y-axis servo cylinder 23 respectively, and finally different types of shear tests are performed on the specimen under a condition of a constant normal load, a dynamic normal load, or constant normal stiffness through the z-axis servo cylinder 11, the x-axis servo cylinder 19, and the y-axis servo cylinder 23 until the specimen reaches a preset shear displacement or deformation, and during the tests, the data collection system collects loading parameters of the z-axis servo cylinder 11, the x-axis servo cylinder 19, and the y-axis servo cylinder 23. Specifically, the shear tests include three types: triaxial simple shear tests, triaxial direct shear tests, and triaxial cyclic shear tests.

In S5, after the specimen reaches the preset shear displacement or deformation, automatic shutdown is performed and test data is saved, and the computer control system 2 processes and analyzes the data collected by the data collection system.

During the test, a rock mass or a soil-rock mixture may be selected as the specimen. In this embodiment, when a direct shear test is performed on the rock mass, the simple shear box 8 is selected for the test. During sample loading, the base 21 is placed on the x-axis friction-reducing roller array 36, the lower stacked-ring shear box 47 is placed on the base 21, a rock mass specimen is then placed into the lower stacked-ring shear box 47, 4 guiding columns 39 pass through the upper stacked-ring shear box 38 and then are inserted into the lower stacked-ring shear box 47, at the same time, the common stacked ring 44 and the acoustic emission stacked ring 43 sequentially sleeve the guiding columns 39 to achieve cascading until a preset height is reached, and finally, the upper stacked-ring shear box 38 is placed at the top of the acoustic emission stacked ring 43, the guiding columns 39 are removed, and then the shear press head 41 is placed. When a simple shear test is performed on the soil-rock mixture, the simple shear box 8 is also selected for the test. During sample loading, after the upper stacked-ring shear box 38 is placed at the top of the acoustic emission stacked ring 43 according to the above sample loading process, a cylindrical rubber sleeve is placed inside the stacked ring, the soil-rock mixture is compacted in layers within the rubber sleeve, then an opening of the rubber sleeve is securely sealed, followed by removing the guiding columns 39 and placing the shear press head 41.

In this embodiment, when a direct shear test is performed on the rock mass, the direct shear box 9 is selected for the test. During sample loading, the base 21 is placed on the x-axis friction-reducing roller array 36, the shear assembly is assembled and then placed in the lower direct shear box 55, the lower direct shear box 55 is then placed on the base 21, then the rock mass specimen is placed in the shear assembly, the upper direct shear box 53 is placed at the top of the lower direct shear box 55, causing the upper direct shear box 53 to sleeve the shear assembly, and finally, the vertical friction-reducing roller array 52 and the friction-reducing plate 51 are sequentially placed between the shear assembly and the upper direct shear box 53, and the shear press head 41 is placed at the top of the upper direct shear box 53.

In this embodiment, when a triaxial simple shear or direct shear test is performed on the specimen under a constant normal load, a shear force is applied to the specimen via the x-axis servo cylinder 19 and the y-axis servo cylinder 23 according to a pre-input constant normal load value until the specimen reaches a designed shear displacement or deformation. When the triaxial simple shear or direct shear test is performed on the specimen under a dynamic normal load, a frequency and an amplitude of the z-axis servo cylinder 11 are set according to pre-input seismic wave transformation, and then a dynamic shear force is applied to the specimen through the x-axis servo cylinder 19 and the y-axis servo cylinder 23 until the specimen reaches the designed shear displacement or deformation. When the triaxial simple shear or direct shear test is performed on the specimen under constant normal stiffness, a constant normal stiffness testing function built in software is activated, an initial normal stress σ0 and a constant normal stiffness coefficient Kn are inputted, and then a shear force is applied to the specimen via the x-axis servo cylinder 19 and the y-axis servo cylinder 23 until the specimen reaches the designed shear displacement or deformation. During the direct shear test, the screw and the connection backup nut 49 configured to connect the x-axis reaction backup nut 46 and the x-axis reaction backing plate 45 may be removed.

In this embodiment, when a triaxial cyclic shear test is performed on the specimen under the constant normal load, a cyclic shear force is applied to the specimen via the x-axis servo cylinder 19 and the y-axis servo cylinder 23 according to the pre-input constant normal load value until the specimen reaches a designed number of times of cyclic shear. When the triaxial cyclic shear test is performed on the specimen under the dynamic normal load, a frequency and an amplitude of the z-axis servo cylinder 11 are set according to pre-input seismic wave transformation, and then a cyclic shear force is applied to the specimen through the x-axis servo cylinder 19 and the y-axis servo cylinder 23 until the specimen reaches the designed number of times of cyclic shear. When the triaxial cyclic shear test is performed on the specimen under the constant normal stiffness, the constant normal stiffness testing function built in software is activated, the initial normal stress σ0 and the constant normal stiffness coefficient Kn are inputted, and then a cyclic shear force is applied to the specimen via the x-axis servo cylinder 19 and the y-axis servo cylinder 23 until the specimen reaches the designed number of times of cyclic shear.

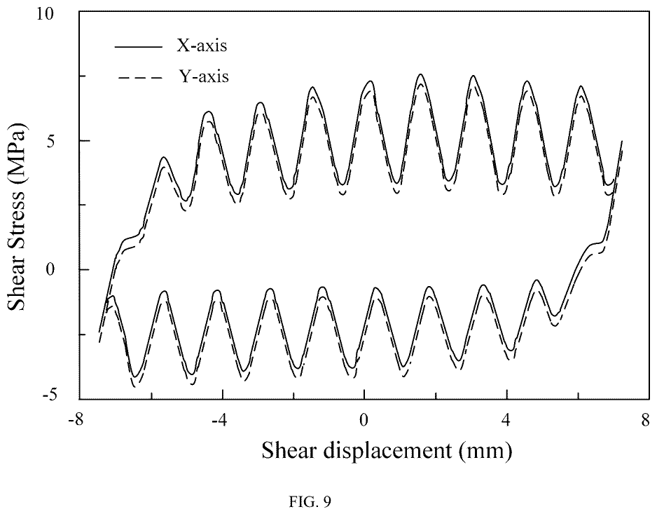

According to the present invention, actual shear tests are performed through the above integrated large-scale triaxial dynamic geotechnical shear testing system, obtaining triaxial direct shear test results as shown in FIG. 8 and triaxial cyclic shear test results as shown in FIG. 9. According to a shear displacement-shear load variation curve in experimental results, the present invention can achieve simple or direct shear and triaxial cyclic shear tests for fractured rock mass specimens and soil-rock mixture specimens under conditions of a constant normal load, a dynamic normal load, and constant normal stiffness. The triaxial cyclic shear test can achieve multi-directional dynamic loading and servo-controlled dynamic shear loading in both horizontal and vertical directions, and can also achieve strain-rate and multi-frequency-band loading under seismic loads (including pulse loads). Therefore, by using the integrated large-scale triaxial dynamic geotechnical shear testing system in the present invention, an influence of seismic motion multi-directionality on dynamic properties of rocks can be studied, which helps reveal a mechanism of slope dynamic instability and has important significance for theoretical research and engineering design of the geotechnical materials.

Although the embodiments of the present invention have been shown and described, those of ordinary skill in the art can understood that various changes, modifications, replacements, and variations may be made to these embodiments without departing from the principles and spirit of the present invention, and the scope of the present invention is defined by the appended claims and equivalents thereof.

What is claimed is:

1. An integrated large-scale triaxial dynamic geotechnical shear testing system, comprising a four-column loading frame (25), and further comprising:
a shear box (17), a z-axis servo cylinder (11), an x-axis servo cylinder (19), a y-axis servo cylinder (23), and a specimen transport system, wherein the shear box (17) is arranged in the four-column loading frame (25), the z-axis servo cylinder (11) is arranged at the top of the four-column loading frame (25) and vertically acts on the shear box (17) through a z-axis press head (16), the x-axis servo cylinder (19) and the y-axis servo cylinder (23) are arranged on side walls of the four-column loading frame (25) and horizontally act on the shear box (17), one side of the four-column loading frame (25) is provided with an opening, the specimen transport system is arranged at the opening, the shear box (17) is transported into the four-column loading frame (25) through the specimen transport system, and the shear box (17) is a simple shear box (8) or a direct shear box (9);
a hydraulic system (3) and a cooling system (4), wherein the hydraulic system (3) is configured to supply hydraulic oil to the z-axis servo cylinder (11), the x-axis servo cylinder (19), and the y-axis servo cylinder (23), and the cooling system (4) is configured to cool the hydraulic oil supplied by the hydraulic system (3);
a data collection system, wherein the data collection system is configured to measure and collect loading parameters of the z-axis servo cylinder (11), the x-axis servo cylinder (19), and the y-axis servo cylinder (23); and
a computer control system (2) and a computer control cabinet (1), wherein the computer control system (2) is electrically connected to the computer control cabinet (1), and the hydraulic system (3), the cooling system (4), and the data collection system are all electrically connected to the computer control system (2);
wherein the direct shear box (9) comprises a base (21), a y-axis friction-reducing roller array (40), a shear press head (41), an x-axis reaction backing plate (45), an x-axis reaction backup nut (46), a y-axis reaction backup nut (48), a connection backup nut (49), a y-axis reaction backing plate (50), an upper direct shear box (53), and a lower direct shear box (55), wherein the lower direct shear box (55) is arranged on the base (21), the upper direct shear box (53) is arranged at the top of the lower direct shear box (55), the shear press head (41) is arranged at the top of the upper direct shear box (53), the y-axis friction-reducing roller array

(40) is arranged, in a rolling manner, at the top of the shear press head (41), the z-axis press head (16) is supported on the y-axis friction-reducing roller array (40), a loading end of the z-axis servo cylinder (11) abuts against the z-axis press head (16), the x-axis reaction backing plate (45) is arranged on a side wall of the lower direct shear box (55), the x-axis reaction backup nut (46) is arranged on the x-axis reaction backing plate (45), a loading end of the x-axis servo cylinder (19) abuts against the x-axis reaction backup nut (46), the y-axis reaction backing plate (50) is arranged on a side wall of the upper direct shear box (53), the y-axis reaction backup nut (48) is arranged on the y-axis reaction backing plate (50) through the connection backup nut (49), and a loading end of the y-axis servo cylinder (23) abuts against the y-axis reaction backup nut (48); and
the direct shear box (9) is provided with a shear assembly, the shear assembly comprising a plurality of integrated shear boxes of different sizes, the plurality of integrated shear boxes being nested sequentially in ascending order of the sizes, a specimen being placed inside the shear assembly, a vertical friction-reducing assembly being arranged between a periphery of the shear assembly and the direct shear box (9), the vertical friction-reducing assembly comprising a vertical friction-reducing roller array (52) and a friction-reducing plate (51), the vertical friction-reducing roller array (52) being located between the shear assembly and the friction-reducing plate (51), the vertical friction-reducing roller array (52) abutting against both the shear assembly and the friction-reducing plate (51), the friction-reducing plate (51) abutting against an inner wall of the upper direct shear box (53) and the friction-reducing plate (51) being provided with a reserved acoustic emission hole (54).

2. The integrated large-scale triaxial dynamic geotechnical shear testing system according to claim 1, wherein the specimen transport system comprises a linear guide rail (29), a triangular support frame (31), a fastening backup nut (32), a reaction pull rod, a tray (34), a friction-reducing ball strip (35), and an x-axis friction-reducing roller array (36), wherein the linear guide rail (29) is fixed at the opening of the four-column loading frame (25) through the triangular support frame (31), the tray (34) is slidably arranged on the linear guide rail (29), the reaction pull rod is arranged on one side of the tray (34), the reaction pull rod passes through a side wall that is on the four-column loading frame (25) and opposite to the opening and is connected to the fastening backup nut (32), the fastening backup nut (32) abuts against an outer side wall of the four-column loading frame (25), a top surface of the tray (34) is provided with a groove along an operating direction of the x-axis servo cylinder (19), the x-axis friction-reducing roller array (36) is arranged, in a rolling manner, at the bottom of the groove, the shear box (17) is arranged in the groove and supported on the x-axis friction-reducing roller array (36), the friction-reducing ball strip (35) is arranged, in a rolling manner, on a side wall of the groove and is in rolling contact with the shear box (17), and a side wall of the tray (34) is provided with a stopper (37) capable of abutting against the x-axis friction-reducing roller array (36).

3. The integrated large-scale triaxial dynamic geotechnical shear testing system according to claim 2, wherein the simple shear box (8) comprises the base (21), an upper stacked-ring shear box (38), a guiding column (39), the y-axis friction-reducing roller array (40) the shear press head (41), an acoustic emission stacked ring (43), a common stacked ring the x-axis reaction backing plate (45), the x-axis reaction backup nut (46), a lower stacked-ring shear box (47), the y-axis reaction backup nut (48), the connection backup nut (49), and the y-axis reaction backing plate (50), wherein the lower stacked-ring shear box (47) is arranged on the base (21), the common stacked ring is arranged at the top of the lower stacked-ring shear box (47), the acoustic emission stacked ring (43) is arranged at the top of the common stacked ring the upper stacked-ring shear box (38) is arranged at the top of the acoustic emission stacked ring (43), the shear press head (41) is arranged at the top of the upper stacked-ring shear box (38), the y-axis friction-reducing roller array (40) is arranged, in a rolling manner, at the top of the shear press head (41), the z-axis press head (16) is supported on the y-axis friction-reducing roller array (40), a loading end of the z-axis servo cylinder (11) abuts against the z-axis press head (16), the guiding column (39) detachably passes through the upper stacked-ring shear box (38) and is downwards inserted into the lower stacked-ring shear box (47), the acoustic emission stacked ring (43) and the common stacked ring sleeve the guiding column (39), the x-axis reaction backing plate (45) is arranged on a side wall of the lower stacked-ring shear box (47), the x-axis reaction backup nut (46) is arranged on the x-axis reaction backing plate (45), a loading end of the x-axis servo cylinder (19) abuts against the x-axis reaction backup nut (46), the y-axis reaction backing plate (50) is arranged on a side wall of the upper stacked-ring shear box (38), the y-axis reaction backup nut (48) is arranged on the y-axis reaction backing plate (50) through the connection backup nut (49), and a loading end of the y-axis servo cylinder (23) abuts against the y-axis reaction backup nut (48).

4. The integrated large-scale triaxial dynamic geotechnical shear testing system according to claim 3, wherein the base (21) is arranged within the groove and supported on the x-axis friction-reducing roller array (36), and the friction-reducing ball strip (35) is in rolling contact with a side wall of the base (21).

5. The integrated large-scale triaxial dynamic geotechnical shear testing system according to claim 3, wherein the data collection system comprises a z-axis magnetostrictive displacement sensor (10), an x-axis magnetostrictive displacement sensor (20), a y-axis magnetostrictive displacement sensor (22), a z-axis shear-beam load cell (14), an x-axis Fulun sensor (18), and a y-axis Fulun sensor (24), wherein the z-axis magnetostrictive displacement sensor (10), the x-axis magnetostrictive displacement sensor (20), and the y-axis magnetostrictive displacement sensor (22) are respectively arranged on a cylinder end face of the z-axis servo cylinder (11), a cylinder end face of the x-axis servo cylinder (19), and a cylinder end face of the y-axis servo cylinder (23), one end of the z-axis shear-beam load cell (14) is connected to the loading end of the z-axis servo cylinder (11) through a load cell backup nut (13), the other end of the z-axis shear-beam load cell (14) abuts against the Z-axis press head (16) through a ball-head compression plate (15), the x-axis Fulun sensor (18) is arranged at the loading end of the x-axis servo cylinder (19) and abuts against the x-axis reaction backup nut (46), and the y-axis Fulun sensor (24) is arranged at the loading end of the y-axis servo cylinder (23) and abuts against the y-axis reaction backup nut (48).

6. The integrated large-scale triaxial dynamic geotechnical shear testing system according to claim 5, wherein the four-column loading frame (25) is provided with a connection base (26) at the top, a cylinder barrel of the z-axis servo cylinder (11) is connected to the connection base (26) through a heightened flange (12), side walls of the four-column loading frame (25) are provided with an x-axis Fulun sensor connecting hole (30) and a y-axis Fulun sensor connecting hole (33), a cylinder barrel of the x-axis servo cylinder (19) is arranged at the x-axis Fulun sensor connecting hole (30) through a coupling flange, the loading end of the x-axis servo cylinder (19) passes through the x-axis Fulun sensor connecting hole (30) and is connected to the x-axis Fulun sensor (18), a cylinder barrel of the y-axis servo cylinder (23) is arranged at the y-axis Fulun sensor connecting hole (33) through a coupling flange, the loading end of the y-axis servo cylinder (23) passes through the y-axis Fulun sensor connecting hole (33) and is connected to the y-axis Fulun sensor (24), and the four-column loading frame (25) is further provided with a hoist ring (27) at the top.

7. A testing method for the integrated large-scale triaxial dynamic geotechnical shear testing system according to claim 2, comprising the following steps:
S1: performing startup and checking whether devices and instruments are normal;
S2: selecting a shear box (17) of a corresponding type and size according to a type and size of the specimen, placing the shear box (17) on the x-axis friction-reducing roller array (36) in the specimen transport system, and then placing the specimen into the shear box (17);
S3: transporting the shear box (17) to a position directly below the z-axis press head (16) by the specimen transport system, causing the reaction pull rod to pass through the side wall of the four-column loading frame (25), and then tightening the fastening backup nut (32);
S4: applying a preset normal pressing force to the shear box (17) through the z-axis servo cylinder (11), then applying an initial tangential pressing force to the shear box (17) through the x-axis servo cylinder (19) and the y-axis servo cylinder (23) respectively, and finally performing different types of shear tests on the specimen under a condition of a constant normal load, a dynamic normal load, or constant normal stiffness through the z-axis servo cylinder (11), the x-axis servo cylinder (19), and the y-axis servo cylinder (23) until the specimen reaches a preset shear displacement or deformation, and collecting, by the data collection system during the tests, loading parameters of the z-axis servo cylinder (11), the x-axis servo cylinder (19), and the y-axis servo cylinder (23); and
S5: after the specimen reaches the preset shear displacement or deformation, performing automatic shutdown and saving test data, and processing and analyzing, by the computer control system (2), the data collected by the data collection system.

8. The testing method for the integrated large-scale triaxial dynamic geotechnical shear testing system according to claim 7, wherein the shear tests comprise three types: triaxial simple shear tests, triaxial direct shear tests, and triaxial cyclic shear tests.
